(19) United States
(12) Patent Application Publication
(10) Pub. No.: US 2016/0010376 A1
(43) Pub. Date: Jan. 14, 2016

(54) FOLDABLE TABLE

(71) Applicant: Biofit Engineered Products, Waterville, OH (US)

(72) Inventors: John DeVriendt, Bowling Green, OH (US); Glenn Siddens, Waterville, OH (US)

(73) Assignee: Biofit Engineered Products, Waterville, OH (US)

(21) Appl. No.: 14/795,336

(22) Filed: Jul. 9, 2015

Related U.S. Application Data
(60) Provisional application No. 62/022,762, filed on Jul. 10, 2014.

(51) Int. Cl. E05D 11/10; A47B 3/08; A47B 3/083

(52) U.S. Cl. CPC E05D 11/105; A47B 3/083; A47B 3/0818

(57) ABSTRACT

The present invention is directed to an adjustable bracket for a lifting mechanism for a folding table. The table has a first section and a second section that are pivotally connected at one end to allow the table to be moved from a folded closed position to an unfolded open position. A torsion bar is operatively connected to the first and second section to provide assistance in moving the table from an open to a closed position. The adjustable bracket has a base position on at least one of the tables. A hollow projection extends from the base and the end of the projection that is spaced apart from the base defines an opening. The opening is configured to engage one end of the torsion bar to fixedly secure the torsion bar to the bracket. A slot is positioned on the base on each side of the hollow projection.

### CROSS REFERENCE TO RELATED APPLICATIONS

This application claims the benefit of U.S. provisional patent application Ser. No. 62/022,762 filed Jul. 10, 2014.

### BACKGROUND OF THE INVENTION

This invention relates to a folded table and more particularly a folding table that moves from a closed folded position to an open unfolded position. The table is normally stored when it is in the folded position and present for use when the table is in the unfolded or open position. The foldable table also utilizes a torsion spring to assist in the movement of the table from a folded to an unfolded position.

Foldable tables have utilized assist devices to help in moving a folding table from a folded closed position to an unfolded open position. Such assist devices are necessary as the tables can be verily large and heavy and it is difficult to move the table from the unfolded open position back to the folded position without such assistance devices. The assistance devices can also function to provide some resistance when the table is being moved from the folded to the unfolded position to prevent the overly rapid movement of the sections of the table as it is unfolded. Torsion springs have frequently been used to provide the assistance for moving the table to the folded closed position. The torsion springs, however, lose some of their lifting force over a period of time. As the tables are frequently quite heavy a relatively small decrease in the lifting force of the torsion spring can result in a significant increase in the force that must be provided by the person that is tasked with folding the table. The decrease in lifting force provided by the torsion spring occurs because the table is frequently in the open position with the spring loaded for extended periods of time. This results in a loss in the lifting force of the torsion spring over a period of time. In addition, the foldable tables are frequently used in large quantities such as in a cafeteria of a school. The person that is charged with folding up many tables at one time objects to the additional lifting force that must be provided when the lifting assist provided by the torsion spring diminishes. Accordingly, there is a need in the industry for a lifting device for foldable tables that can compensate for the decrease in lifting force provided by a biasing spring such as a torsion bar.

### SUMMARY OF THE INVENTION

The present invention is directed to an adjustable bracket for a lifting mechanism for a folding table. The table has a first section and a second section that are pivotally connected at one end to allow the table to be moved from a folded closed position to an unfolded open position. A torsion bar is operatively connected to the first and second section to provide assistance in moving the table from an open to a closed position. The adjustable bracket has a base positioned on at least one of the tables. A hollow projection extends from the base and the end of the projection that is spaced apart from the base defines an opening. The opening is configured to engage one end of the torsion bar to fixedly secure the torsion bar to the bracket. A slot is positioned on the base on each side of the hollow projection. The slots have a length that is from about 2 to about 4 times the diameter of a fastener used to secure the base to at least one of the first or second sections of the table. The slots are designed to allow the bracket to be positioned to achieve the desired level of tension in the torsion bar.

The various features of the invention can be employed to provide advantages over the prior art. In particular, the bracket can be utilized to restore the full lifting force provided by the torsion bar. Other features and advantages of the invention will be more completely understood by referring to the attached drawings in connection with the following description.

### BRIEF DESCRIPTION OF THE DRAWINGS

FIG. 1 is a side elevational view of a foldable table of the present invention in the folded or closed position.

FIG. 2 is a perspective view of the foldable table in the unfolded or open position.

FIG. 3 is a partial side elevation view showing the torsion bar and support leg structure.

FIG. 4 is a partial perspective view of the torsion bar and support leg structure.

FIG. 5 is a side elevation view of the mounting bracket for the torsion bar.

FIG. 6 is a perspective view of the mounting bracket for the torsion bar.

FIG. 7 is a partial perspective view of the table.

### DETAILED DESCRIPTION OF THE PREFERRED EMBODIMENT(S)

The invention is directed to a foldable table that can be moved from a folded position to an open position where the table is oriented for use. More particularly, the table has at least one torsion bar that is twisted or rotated and to generate a biasing force when the table is moved from the folded to the open position. An adjustable bracket is used to mount the torsion bar to the foldable table to provide for an adjustment on the biasing force that is provided by the torsion bar. The features and advantages of the present invention will be more readily understood by referring to the attached drawings and the following description of the invention.

A general description of the details of a prior art foldable table is shown in U.S. Pat. No. 3,075,809 and the teachings of this patent are incorporated by reference into this patent application.

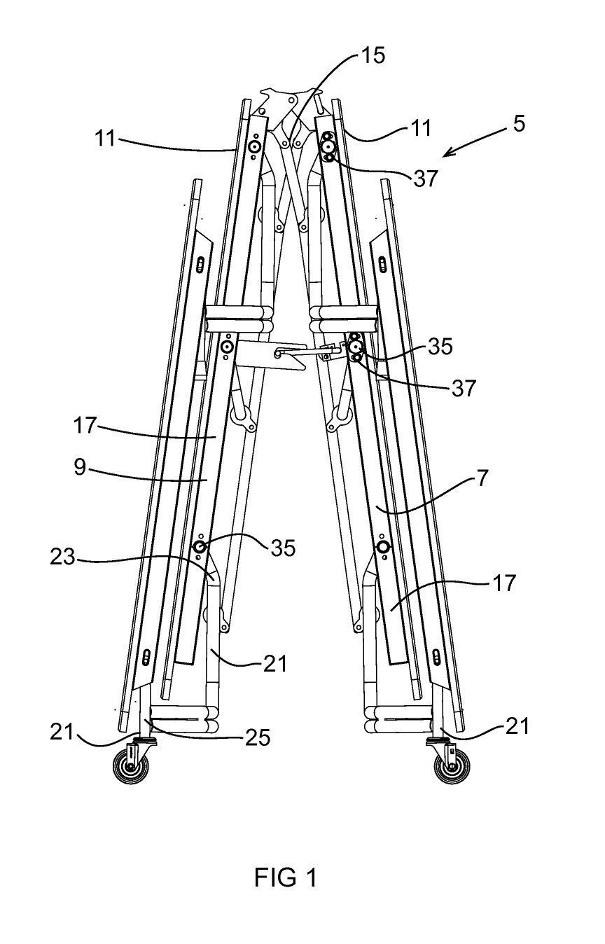

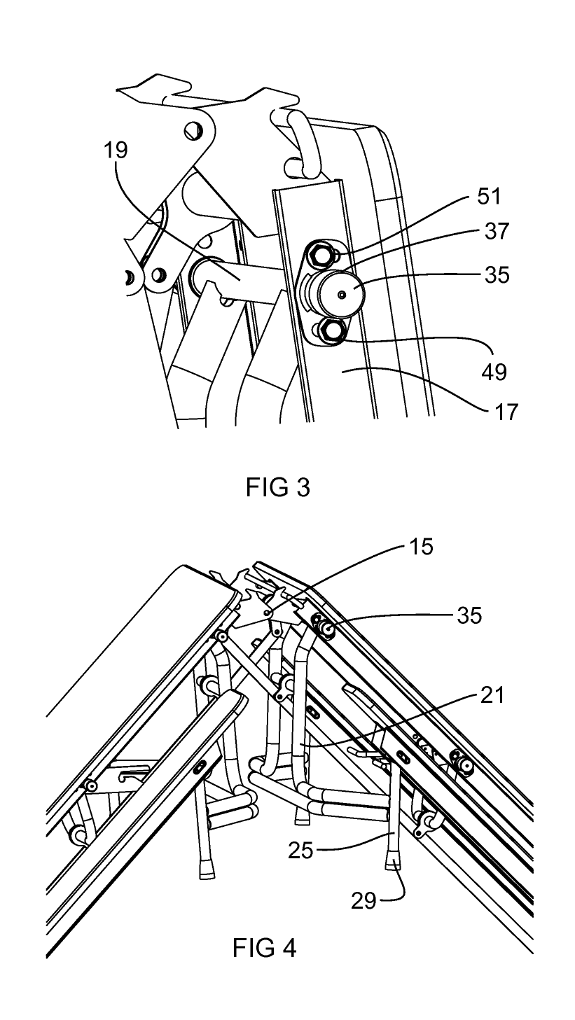

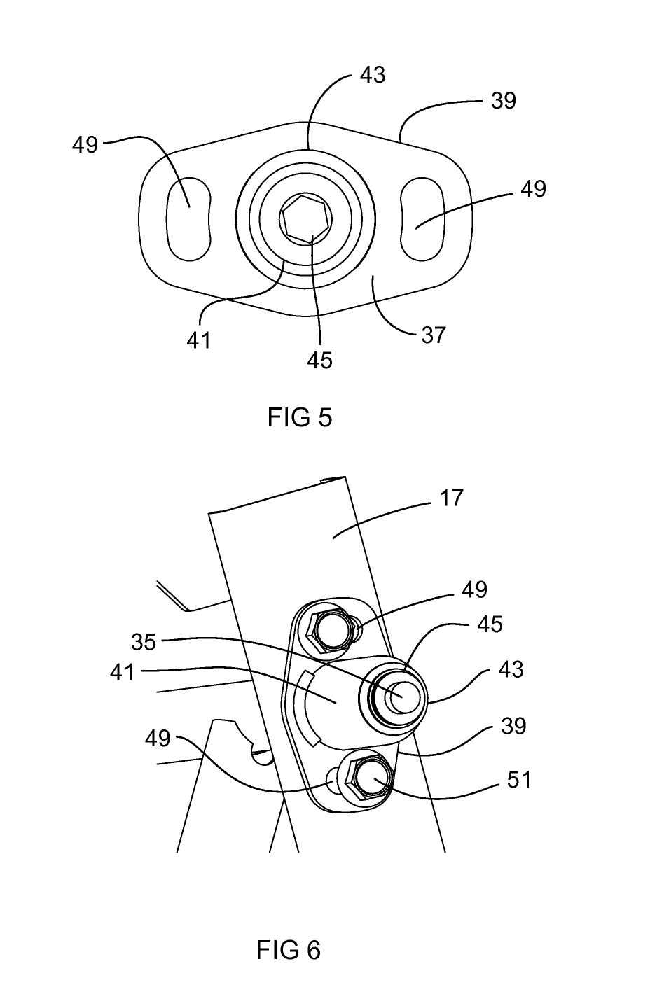

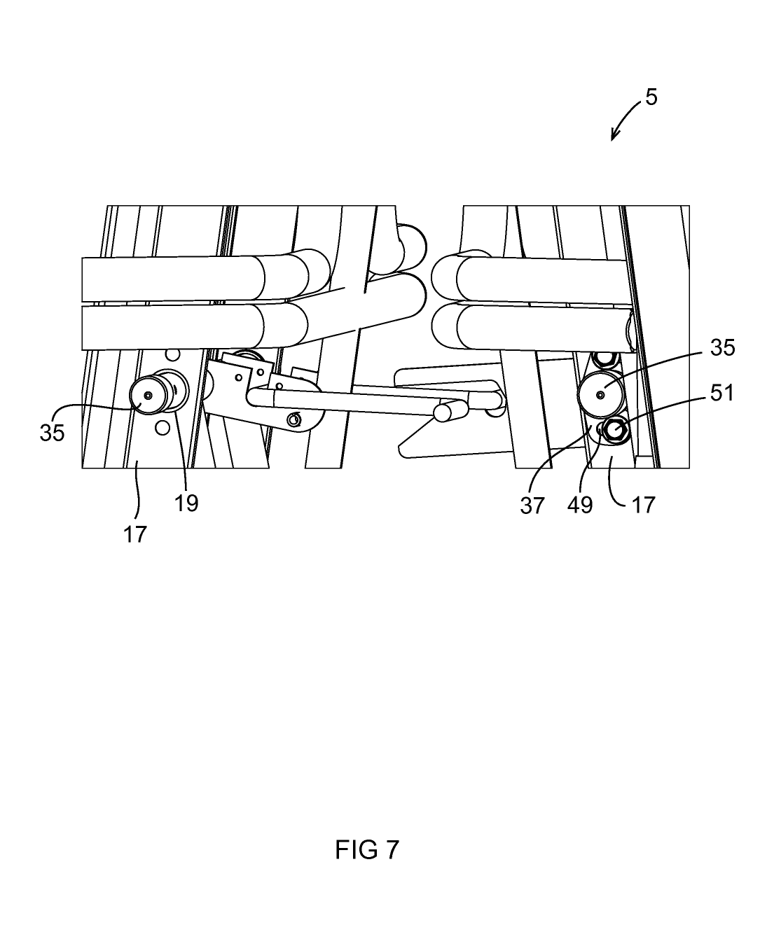

As shown in FIGS. 1-6, the table 5 has a first table section 7 and a second table section 9. The first and second table sections have a first end 11 that are operatively connected together by a hinge mechanism 15. A pair of rails 17 are positioned on one side of the first and second table sections. The rails are on the side of the first and second table sections that face the ground when the foldable table 5 is in the unfolded open position. A plurality of support legs 21 have a first end 23 that is pivotally connected to the rail 17 of the flexible table 5. The second end 25 of the support legs 21 have a caster or roller 27 or a support foot 29 mounted thereon.

The first end 23 of the support legs 21 is mounted to a torsion bar 35 that extends between the rails 17. The first end 23 of the support legs 21 is secured to the torsion bar 35. One end of the torsion bar is secured to one of the rails 17 by a bracket 37. The other end of the torsion bar is rotatably mounted in an aperture 19 the rail 17 that is opposite to the rail where the bracket 37 secures the torsion bar to the table. The bracket 37 has a base 39 that is positioned against the rail 17. The base has a hollow projection 41 that extends from the base in a direction away from the rail. 17. The end 43 of the hollow projection that is spaced apart from the base 39 defines an opening 45. The opening 45 is configured to engage the end of the torsion bar 35 that is positioned in the bracket 37 to prevent the end of the torsion bar secured in the opening 45 from rotating. In practice, it has been found useful to provide a hexagonal shape on the end of the torsion bar 35 that is positioned in the bracket 37. The opening 45 in the hollow projection 41 of the bracket 37 is designed to have a hexagonal shape that can engage the end of the torsion bar 35. The interaction between the hex shape of the opening 45 and the hexagonal shape of the torsion bar 35 prevents the end of the torsion bar secured in the opening 45 from rotating. A pair of slots 49 are disposed on the base 39 of the bracket 37 on opposite sides of the hollow projection 41. The slots are designed to accommodate a securing means 51, such as a bolt, to releaseably secure the bracket 37 to the rail 17. The slots 49 have a length that is from about 2 to 4 times the diameter of the fastener or bolt 51. The length of the slots is designed to allow for the torsion bar 35 that is secured to the bracket 37 to be able to rotate from about 1° to about 20°. This rotation is accomplished by loosening the bolt 51 and allowing the bracket to move within the space provided by the slots 49. It is critical that the slots allow for an adjustment range for the torsion bar that is sufficient to recover the lifting for in the torsion bar. The slots 49 are designed to allow the bracket to be positioned on the rail 17 in a manner to achieve the desired tension in the torsion bar 35.

The foldable table 5 can have torsion bars 35 that are connected to all of the supports legs 21 for the table. A torsion bar 35 can even be connected to the linkage that helps position the first and second table sections as the table is moved from a folded position to an open position where the table can be effectively used.

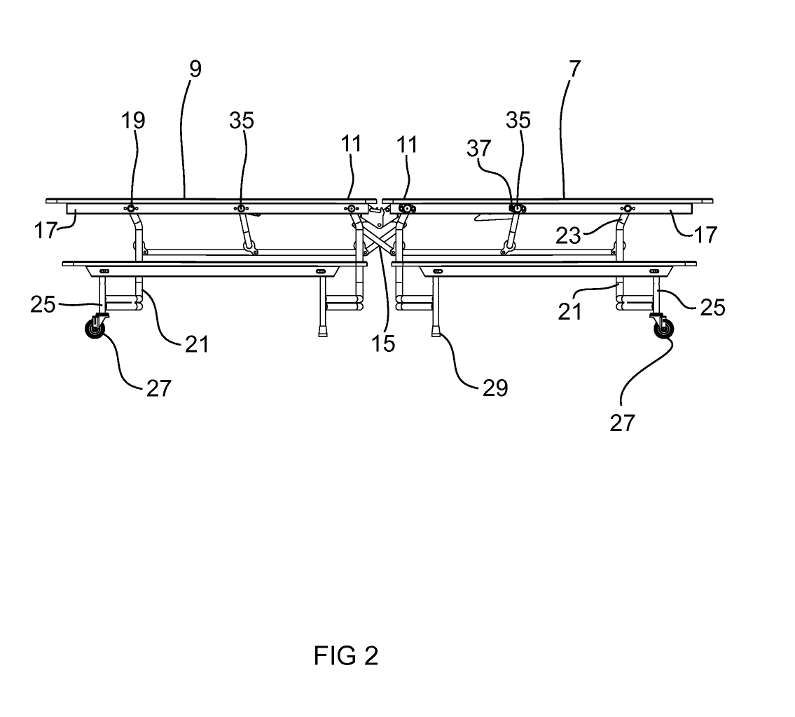

In operation the foldable table 5 is normally stored in the folded position as shown in FIG. 1. When it is desired to use the table the table is moved to the unfolded or open position as shown in FIG. 2. As the table is unfolded the support legs 21 are rotated with respect to the first and second table sections so that the support legs are in the proper position for supporting the first and second table sections when the table 5 is in the unfolded open position. The rotation of the support legs, and also possibly the connecting linkage, that are connected to a torsion bar 35 will cause the torsion bar to be rotated or twisted. As one end of the torsion bar is securely held in the bracket 37 the twisting of the torsion bar will generate a biasing or spring force in the torsion bar. The level of the biasing force in the torsion bar will be the greatest when the table is in the fully open unfolded position. The biasing force in the one or more torsion bars is designed to provide assistance when it is desired to move the table from the open position back to the folded closed position. The one or more torsion bars are designed to provide a significant portion of the force necessary to move the table from the open to the closed position. Normally, however, the one or more torsion bars do not provide all of the lifting force necessary to move the foldable table from the folded to the open position.

Frequently the foldable table 5 is maintained in the open position for significant periods of time. Maintaining the one or more torsion bars in a position where they are subjected to the full twisting force provided by the open table eventually results in some diminishment in the biasing force that is provided by the one or more torsion bars when it is time to move the foldable table from the open unfolded position to the closed folded position. Over a period of time it is not unusual for the one or more torsion bars to lose from about 5% to about 20% of the biasing force originally provided by the one or more torsion bars. This reduction in the biasing force for the one or more torsion bars can significantly increase the force necessary to move the table from the open to the closed position. It has been found that one or more torsion bars lose from about 3° to about 10° of rotation which equates to about 5% to about 20% of the lifting force of the one or more torsion bars. On a normal foldable table there are frequently six torsion bars that are utilized to assist in moving the table from an open unfolded position to a closed folded position. Each of the torsion bars provide approximately from about 50 lb./ft. to about 150 lb./ft. with a preferred range from about 80 lb./ft. to about 100 lb./ft. of torque to assist in folding the table. If each of the torsion bars loses only 5% of its lifting force this results in a 25 to 30 pound/foot decrease in the biasing force provided by the torsion bars. To fold the table 5 when the one or more torsion bars 35 have lost some of their biasing force it is necessary for the person folding the table to provide the additional force to fold the table. Asking a person to provide this additional force makes it much more difficult for the person to effectively fold the table 5. In many applications the tables are used in large groupings such as a cafeteria or meeting room and there are several tables that are routinely moved from a folded storage position to an open use position during a course of a day. The increase in the force that must be provided by the staff in closing the tables becomes a significant issue that makes such foldable tables less desirable in the marketplace. Accordingly, there is a need in the marketplace for a foldable table that does not lose a significant portion of the biasing force from the one or more torsion bars that are designed to assist in folding the table.

It has been found that a force provided by the one or more torsion bars 35 can be restored by loosening the bolts 51 that are in slots 49 in the base 39 of the bracket 37 when the table is in the folded or closed position. In this position there is very little twisting force on the torsion bars 35 from the support legs 21, but a torsion bar that has lost some of its biasing force does not return to an untwisted neutral position. Frequently a torsion bar has lost from about 3 degrees to about 8 degrees of rotation as positioned in the table 5. By loosening the bolts 51 the residual biasing force in the one or more torsion bars 35 will cause the bracket 37 to move to a neutral position for the one or more torsion bars where there is no residual twisting force on the one or more torsion bars. When the torsion bar is back to the neutral position the bolts 51 can be tightened and the one or more torsion bars have effectively moved to a position where they will provide essentially the full biasing force when the table is again moved from closed folded position to the open unfolded position. It has been found that the one or more torsion bars 35 lose from about 3 to about 8 degrees of rotation over a period of time and the slots 49 in the base 39 of the bracket 37 must be long enough to allow for this degree of rotation for the bracket 37 to return the one or more torsion bars to the neutral position. The slots 49 allow for from about 1° to about 20° of rotation to accommodate the changes in the torsion bars over time. It should also be recognized that the individual torsion bars may have a different level of diminishment in the biasing force and loss of rotation for the torsion bar. This is not a significant factor because the slots 49 on the bracket 37 can allow each torsion bar to return to its untwisted neutral position and each of the torsion bars will be individually adjusted.

The above detailed description of the present invention is given for explanatory purposes. It will be apparent to those skilled in the art that numerous changes and modifications can be made without departing from the scope of the invention. Accordingly, the whole of the foregoing description is to be construed in an illustrative and not a limitative sense, the scope of the invention being defined solely by the appended claims.

We claim:

1. An adjustable torsion cap for a lifting mechanism for a folding table, the table having a first section and a second section, the first and second sections being connected at a pivot point to allow the table to be moved from a folded closed position to an unfolded open position, a torsion bar being operatively connected to the first and second sections, the torsion bar providing assistance to move the table from an open to a closed position, the adjustable cap comprising:
a base positioned on the first section of the table;
a hollow projection extending from the base, the end of the hollow projection extending from the base defining an opening, the opening configured to engage one end of the torsion bar;
a slot positioned on the base on each side of the hollow projection, the slot having a length that allows the torsion cap to accommodate from about 1° to about 20° of rotation of the torsion bar, the slots being designed to allow the torsion cap to be positioned to achieve the desired tension in the torsion bar.

2. The cap of claim 1 wherein more than one torsion bar is positioned on the table and a cap is associated with each torsion bar.

3. The cap of claim 1 wherein a rail extends along an edge of the first and second sections.

4. The cap of claim 3 wherein the base is positioned on the rail.

5. The cap of claim 1 wherein the opening in the hollow projection engages the one end of the torsion bar to secure the one end from rotating relative to the base.

6. The cap of claim 5 wherein the opening and the one end of the torsion bar have a hex shape that are designed to mateingly engage.

7. The cap of claim 1 wherein another end of the torsion bar engages a support leg of the table, the support leg being designed to rotate from a folded position to an open position, in the open position the support leg supports the table in a use position, the other end of the torsion bar rotating with the rotation of the support leg.

8. The cap of claim 7 wherein a linkage is provided for securing the support leg in the open position.

9. The cap of claim 1 wherein the slots can allow the torsion bar to rotate from about 3° to about 10° to achieve the desired tension.

10. A method for adjusting the tension on a torsion spring for a folding table, the folding table having a first section and a second section pivotably connected for moving from a folded closed position to an unfolded open position, the torsion spring providing assistance to move the table from the open to the closed position comprising:
positioning a bracket on the first section of the table, the bracket having at least one slot that is used to secure a fastener to secure the bracket to the first section, the slot being designed to allow the bracket to be adjusted in an angular manner with respect to the first section;
positioning one end of a torsion spring in the bracket, moving the table from the closed position to the open position causing the torsion spring to be twisted and to create a biasing force that assists in moving the table from the open position to the closed position; and
adjusting the biasing force provided by the torsion spring by adjusting the position of the bracket with respect to the first section.

11. The method of claim 10 in which the one end of the torsion bar is secured to the bracket to prevent the one end from moving relative to the bracket.

12. The method of claim 11 in which an other end of the torsion bar is secured to a portion of the table wherein the other end of the torsion bar is caused to twist due to the movement of the table from a closed to an open position.

13. The method of claim 12 in which the other end of the torsion bar is secured to a support leg that moves from a folded position to a support position as the table is moved to an unfolded open position.

14. The method of claim 10 in which the forces in the torsion bar will cause the bracket to move to the position where the force in the torsion bar has been adjusted to the desired level.
